(19) United States
(12) Patent Application Publication
(10) Pub. No.: US 2004/0197472 A1
(43) Pub. Date: Oct. 7, 2004

(54) Process and apparatus for sealing freezer enclosures from moisture and contamination

(76) Inventors: Harry J. Scofield, Northfield, MN (US); James A. Ehret, Norwalk, OH (US); Michael Brodziak, Northfield, MN (US); David Walter Brown, Oak Ridge, TN (US)

Correspondence Address: PAULEY PETERSEN & ERICKSON, 2800 WEST HIGGINS ROAD, SUITE 365, HOFFMAN ESTATES, IL, 60195, US

(21) Appl. No.: 10/719,681

(22) Filed: Nov. 21, 2003

Related U.S. Application Data
(60) Provisional application No. 60/460,466, filed on Apr. 4, 2003.

(51) Int. Cl. B05D 7/22; B05C 11/11

(52) U.S. Cl. 427/237; 312/404; 156/60; 118/504

(57) ABSTRACT

A protective coating and a method for applying the protective coating to a wall of a freezer enclosure includes applying a screen to the wall wherein the screen includes a plurality of intersecting elements forming a plurality of openings. One or more coatings of a polymer are then applied to the screen in a sufficient quantity to coat the screen and permeate the plurality of openings through to the wall. The polymer is then allowed to solidify or cure thereby creating a temperature, abrasion and chemical resistant protective coating on or within the freezer enclosure.

### BACKGROUND OF THE INVENTION

1. Field of the Invention

This invention relates to a method and apparatus for sealing freezer enclosures from moisture and contamination.

2. Description of Prior Art

Commercial freezers are typically high-volume enclosures assembled from large panels of stainless steel. Stainless steel provides a sterile and cleanable environment that is required for enclosures for storing food products, particularly when such food products may be susceptible to and/or may result in contamination.

One limitation of such freezers are the seams at which the panels of stainless steel are joined. Such seams are typically caulked and may later become susceptible to contamination and bacteria from the food products and the water used to wash the inside of such freezers. Water may become entrained in such seams and permanently contaminate the area behind and beneath the panels within the freezer.

As a result, such freezers require frequent re-caulking; are susceptible to food safety problems; may permit moisture accumulation under the floor and walls; and may permit rust within the enclosure.

Accordingly, a suitable method and apparatus for sealing such freezer enclosures is desired.

### SUMMARY OF THE INVENTION

It is therefore an object of this invention to provide a method and apparatus for sealing a freezer enclosure that does not permit contamination or buildup of contaminants, such as within the seams between panels and the floor of the steel enclosure.

It is one object of this invention to provide a method and apparatus for sealing a freezer enclosure that results in a homogenous, sterile coating along inner surfaces of the freezer enclosure.

It is one object of this invention to provide a freezer enclosure that may be cleaned with water and a caustic cleaning solution without risk of entrainment of contaminated water in the freezer enclosure.

It is another object of this invention to provide a protective coating for a freezer enclosure that is abrasion, temperature and chemical resistant.

It is yet another object of this invention to provide a protective coating that may be applied quickly and efficiently and, if necessary, has a fast cure rate.

According to one preferred method of this invention for applying a protective coating to a wall of a freezer enclosure, a screen is applied to the joints and seams of the walls, ceiling, floor and/or other portions of the freezer enclosure. The screen preferably includes a plurality of intersecting elements forming a plurality of openings.

A polymer, preferably non-solvent based and comprising a polyurea coating or similar polymer, is then applied on and through the screen and the underlying surface. The polymer is preferably a quick-setting application and may comprise a mixture of two compositions applied simultaneously, termed component A and component B herein.

Component A and component B are preferably liquids and are supplied to a pump imparting high pressure on the liquids. Under preferred conditions, component A and component B are thoroughly mixed as they are spray applied thereby forming the solvent-based polymer protective coating. One or more coats of the polymer are applied to the screen in a sufficient quantity to coat the screen and permeate the plurality of openings.

Following application, the polymer is allowed to solidify or cure into a hard, abrasion, temperature and chemical resistant protective coating that both seals and protects the freezer enclosure.

### BRIEF DESCRIPTION OF THE DRAWINGS

The above-mentioned and other features and objects of this invention will be better understood from the following detailed description taken in conjunction with the drawings wherein:

FIG. 1 is a schematic cutaway view of a wall having a protective coating according to one preferred embodiment of this invention; and

FIG. 2 is a schematic side view of a freezer enclosure having a protective coating according to one preferred embodiment of this invention.

### DESCRIPTION OF PREFERRED EMBODIMENTS

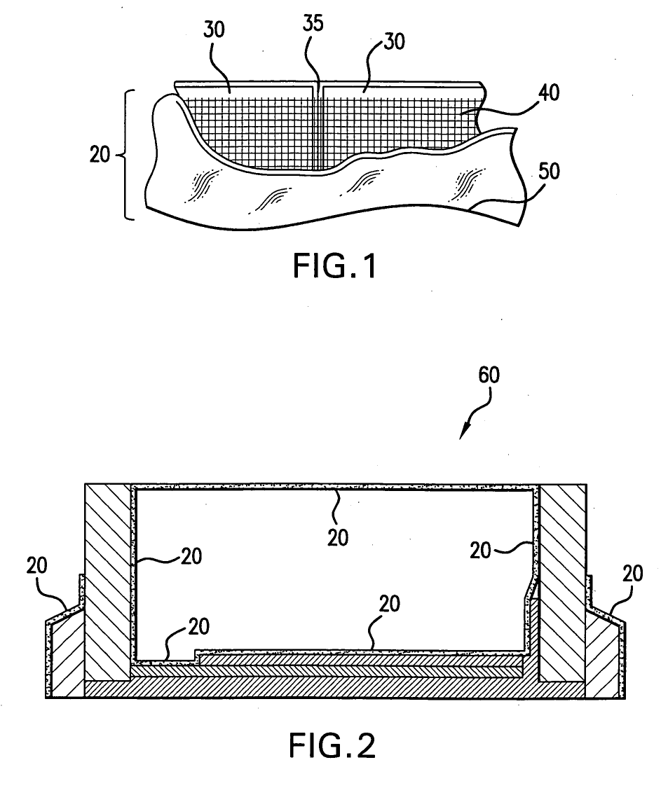

FIG. 1 shows a schematic view of an application of a protective coating 20 to a wall 30 of a freezer enclosure according to one preferred embodiment of this invention. As shown schematically, a screen 40 is applied to the wall 30, or as shown two walls 30 having a seam 35 between, and one or more layers of a polymer 50 is then applied to the screen 40 and the wall 30. As a result, the protective coating 20 is affixed to the wall 30 of the freezer enclosure that is abrasion, temperature and chemical resistant and impervious to contamination from bacteria and other contaminants prevalent in a food storage environment.

FIG. 2 shows a schematic view of a freezer enclosure 60 having the protective coating 20 provided along multiple critical surfaces. The method according to this invention may be applied to any and all surfaces of a freezer enclosure including inner and outer surfaces, floors, ceilings, walls, shelves, hangers and fixtures. A desired protective coating includes no seams, holes, cracks, wells or other areas that may trap or accumulate water, particulate and/or contaminants. The term “freezer” as used in the specification and claims may include any refrigeration and/or freezer device, cold storage facility and/or similar enclosure for maintaining reduced temperatures.

Prior to application of the screen, extraneous fixtures, belts and hystrels are removed from the interior of the freezer enclosure. “Z” flashing is removed together with caulk and other prior seals that may have been employed in the freezer enclosure.

In addition, one or more walls of the enclosure are thoroughly cleaned, preferably using a technique called sodablasting. The walls, including wall panels, cracks, crevices, floors and ceilings are preferably sodablasted using a high pressure spray of water and an environmentally safe, non-warping composition similar to conventional baking soda. Sodablasting will clean steel enclosures and not cause damage such as flash rusting or abrasion on such steel surfaces. Freezer enclosures typically include stainless steel and/or galvanized steel panels.

According to one preferred method of this invention for applying a protective coating to a wall of a freezer enclosure, the screen is applied to the wall, the screen including a plurality of intersecting elements forming a plurality of openings. The screen preferably includes openings between ⅛ inch and ½ inch. The screen may be applied using a plurality of fasteners, such as self drilling screws, that are fastened through the screen and to the wall. Alternatively, the screen may be retained with adhesive or any other suitable fastening means known to those having ordinary skill in the art.

According to one preferred embodiment of this invention, the screen comprises a mesh, netting, scrim or similar material having a plurality of intersecting elements forming a plurality of openings. The screen may be fabricated from metal, plastic, composite or other material having desired characteristics including flexibility, strength and abrasion, temperature and/or chemical resistance. Such characteristics preferably permit the screen to retain movement of the protective coating relative to the panels of the enclosure.

According to one preferred embodiment of this invention, the polymer comprises a polyurea coating and is preferably non-solvent based. The polyurea coating is preferably a quick-setting application and therefore may comprise a mixture of two compositions applied simultaneously.

The two compositions, component A and component B, forming the polyurea coating are preferably mixed directly prior to application. Component A preferably comprises: between approximately 30% and 60% diphenylmethane diisocynanate; between approximately ˜30% and 60% modified MDI; and between approximately 1% and 10% MDI homopolymer. The diphenylmethane diisocynanate preferably includes approximately 35% 4,4′-MDI and MDI isomers. Component B preferably comprises: between approximately 1% and 40% N,N′ dialkylamino-diphenylmethane; between approximately 1% and 50% diethyltoluenediamine; between approximately 1% and 30% poly(oxy(methyl-1,2-ethanediyl)), Alpha-(2-aminomethylethyl) omega-(2-aminomethylethoxy); and between approximately 1% and 20% glyceryl poly(oxypropylene) triamine.

Component A and component B are preferably liquids and are supplied to a pump imparting high pressure on the liquids. The two components are preferably heated in the pumping cycle and mixed as the two components enter and exit a spray gun attached with respect to the pump. The heater may be integrated with the pump. Alternatively, or in addition, a hose linking the pump to the spray gun may be heated or extended through a heated vessel.

Under the correct conditions, component A and component B are thoroughly mixed as they are spray applied thereby forming the polyurea coating. According to one preferred embodiment of this invention, the spray gun may be a GUSMER GX-8 or GX-7-400 spray gun, available from Gusmer Corporation located in Lakewood, N.J. The preferred spray gun will facilitate proper mixing prior to application of the polymer.

One or more coats of the polymer are applied to the screen in a sufficient quantity to coat the screen and permeate the plurality of openings. Because of the reactive nature of the two components, the film of protective coating begins to form immediately. Multiple coats of the polymer may be applied to create a seamless coating along the desired surfaces of the freezer enclosure.

According to a preferred embodiment of this invention, and in accordance with the desired physical properties of the materials, the polyurea coating is applied in ambient temperatures above freezing and more preferably above 40 degrees Fahrenheit. Therefore, if the protective coating is added as a retrofit, the freezer enclosure is shut down and thawed prior to application and preferably prior to the cleaning step so as to provide a substrate, such as the walls, that are approximately equal in temperature to the ambient air.

Following application, the polymer is allowed to solidify or cure into a hard, abrasion, temperature and chemical resistant protective coating that both seals and protects the freezer enclosure. According to one preferred embodiment of this invention, the polymer coating is cured with heat, such as a heat gun and/or portable electric heaters.

Following solidification and/or curing, the protective coating preferably sanitized to ensure sterility prior to contact with food product. According to one preferred embodiment of this invention, the protective coating is sanitized using a controlled steam injection. Such steam injection/cleaning assures a definite kill step, particularly of bacteria and other contaminants, such as Listeria, that are problematic in freezer enclosures.

As discussed above, the polymer that is applied to the base substrate, such as the screen, preferably includes, but is not limited to, polyurea, polyurethane, epoxy, polyurethane-polyurea hybrids or other similar polymer. The desired polymer is polyurea. Polyureas are typically supplied in monomer form as two solutions. One solution is an isocyanate and the second solution is a polyamine. The resulting polymer after mixing the two components is a polyurea. The general reaction is shown as follows:

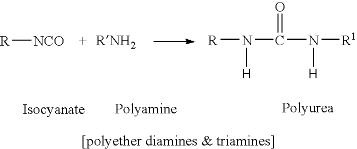

Another desired polymer is polyurethane which is supplied as two components, an isocyanate and a polyether polyol. The two solutions are mixed immediately before application to the base substrate. The polyurethane system requires the use of a catalyst such as Dibutylatin dilaurate. The general reaction for the production of a polyurethane polymer is as follows:

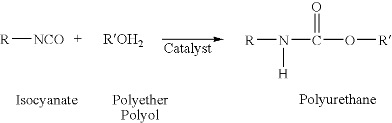

For the application of polyurea to a base substrate, a polyether polyamine is mixed with the isocyanate immediately before the application of the mixture. The mixing of the two components is typically done in a spray gun and the mixture is sprayed onto the base substrate. Polyurea is the desired coating because the formation of the polymer does not require a catalyst and the reaction is relatively temperature insensitive as well as relatively insensitive to water. Also, since Polyurea has no “VOC”s the utilization of Polyurea does not cause any. EPA problems for the applicator.

According to preferred embodiments of this invention, polyamines that can be used in practicing the present invention include, but are not limited to, Jeffamine® D2000 and Jeffamine® T5000, manufactured by Huntsman Corp., Houston, Tex., which are amine-terminated polypropylene glycols which have the following general structure:

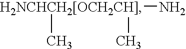

ETHACURE® 100 manufactured by Albemarle Corporation of Baton Rouge, La. which is diethyltoluenediamine; and UNILINK® 4200 manufactured by UOP of Des Plaines, Ill. which has the following formula:

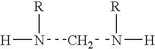

The preferred urethane is diphylmethane diisocyanate such as that manufactured by ICI of West Deptford, N.J. The polyamines can be mixed together to form the desired physical properties. According to a preferred embodiment of the present invention, FRIGOSEAL™, the resulting polyurea should be rigid and exhibit a high tensile strength.

In practicing the present invention, the polyamines and the urethane solutions (Component A and Component B, respectively) are preferably mixed immediately before application to the base substrate. The mixing preferably occurs in the application gun under pressure and the resulting mixture is applied uniformly to the base substrate. The mixture that is applied to the base substrate cures rapidly and results in a uniform coating. The thickness of the coating according to the present invention will vary depending upon the final physical qualities desired. The thickness of the coating is generally between approximately 1 mils and 250 mils with a preferable thickness of between 60 and 75 mils and a more preferable thickness of approximately 62.5 mils which is 1/16 of an inch.

### EXAMPLE 1

A test surface was sprayed with a polyurea formulation having the following formula:

| Component A | |
|---|---|
| UNILINK 4200 | 5.0% |
| JEFFAMINE D2000 | 64.0% |
| ETHACURE 100 | 23.125% |
| JEFFAMINE T5000 | 8.0% |
| BioCide | 1% |
| Component B | |
| Rubinate 9432 | 100% |

The components of Component A were mixed together and the polymer solution (Component A and Component B) was applied using a plural component spray machine to a thickness of approximately 62.5 mils. Recent advances in spray equipment designs have significantly contributed to the development of these 100% solids spray polyurea elastomer systems.

In order to process this technology, high pressure, impingement mix spray equipment is preferred. The instant reaction of the amine-terminated polyether resins with the isocyanate results in rapid viscosity increases in the mixing system. Heating capability of the spray equipment is important for lowering the mix viscosity so as to improve spray processing. High pressure is desirable to adequately mix these highly reactive systems. Non impingement mix processing fails to give proper mixing of the two components.

This relatively low cost, commercially available equipment can be used to process a wide variety of two component systems and there are several brands available. Material recirculation is not recommended and a temperature of 150 degrees F. should be maintained at the point of mixing. Pressures at mix can vary with mix chamber design but generally will range in the 1600 psi up to 2500 psi.

### EXAMPLE 2

A freezer panel was sprayed with a polyurea formulation having the following formula:

| Component A | |
|---|---|
| Unilink 4200 | 3.0% |
| Jeffamine D2000 | 65.875% |
| Ethacure 100 | 23.125% |
| FMC-1035 | |
| Jeffamine T5000 | 8.0% |
| BioCide | 1% |
| Component B | |
| Rubinate 9432 | 100% |

The components of Component A were mixed together and the polymer solution (Component A and Component B) was applied using a plural component spray machine to a thickness of approximately 62.5 mils.

While in the foregoing specification this invention has been described in relation to certain preferred embodiments thereof, and many details have been set forth for purpose of illustration, it will be apparent to those skilled in the art that this invention is susceptible to additional embodiments and that certain of the details described herein can be varied considerably without departing from the basic principles of the invention.

We claim:

1. A method for applying a protective coating to a wall of a freezer enclosure comprising the steps of:
applying a screen to the wall, the screen including a plurality of intersecting elements forming a plurality of openings;
applying one or more coatings of a polymer to the screen in a sufficient quantity to coat the screen and permeate the plurality of openings through to the wall; and
solidifying the polymer.

2. The method of claim 1 wherein the polymer comprises a polyurea coating.

3. The method of claim 1 wherein the polyurea coating is a mixture of two compositions.

4. The method of claim 3 wherein one of the two compositions forming the polyurea coating comprises:
between approximately 1% and 40% N,N¹ dialkylamino-diphenylmethane;
between approximately 1% and 50% diethyltoluenediamine;
between approximately 1% and 30% poly(oxy(methyl-1,2-ethanediyl)), Alpha-(2-aminomethylethyl) omega-(2-aminomethylethoxy); and
between approximately 1% and 20% glyceryl poly(oxypropylene) triamine.

5. The method of claim 3 wherein one of the two compositions forming the polyurea coating comprises:
between approximately 30% and 60% diphenylmethane diisocynanate;
between approximately 30% and 60% modified MDI; and
between approximately %1 and 10% MDI homopolymer.

6. The method of claim 3 further comprising the step of:
mixing the two compositions under pressure.

7. The method of claim 3 further comprising the step of:
applying the two compositions under pressure.

8. The method of claim 1 further comprising:
applying the coating in ambient temperatures above freezing.

9. The method of claim 1 further comprising the step of:
sodablasting the wall prior to application of the polymer.

10. A method for sealing a freezer enclosure comprising the steps of:
applying a screen to a wall of the freezer enclosure, the screen including a plurality of intersecting elements forming a plurality of openings;
applying a two component polyurea coating to the screen in a sufficient quantity to coat the screen and permeate the plurality of openings; and
curing the polyurea coating.

11. The method of claim 10 further comprising the steps of:
mixing the two components of the polyurea coating under pressure;
spraying the two components of the polyurea coating onto the screen.

12. The method of claim 11 further comprising the step of:
heating the two components of the polyurea coating prior to mixing.

13. The method of claim 10 wherein the polyurea coating is cured with heat.

14. The method of claim 10 further comprising the step of:
sanitizing the cured polyurea coating with a controlled steam injection.

15. An apparatus for coating a freezer enclosure having steel walls comprising:
a screen positioned against the walls of the freezer enclosure, the screen having a plurality of intersecting elements forming a plurality of openings;
a cured polyurea coating on the screen and through the plurality of openings of the screen.

16. The apparatus of claim 15 wherein the cured polyurea coating comprises:
a mixture of a first component and a second component, the first component including:
between approximately 1% and 40% N,N′ dialkylamino-diphenylmethane;
between approximately 1% and 50% diethyltoluenediamine;
between approximately 1% and 30% poly(oxy(methyl-1,2-ethanediyl)), Alpha-(2-aminomethylethyl) omega-(2-aminomethylethoxy); and
between approximately 1% and 20% glyceryl poly(oxypropylene) triamine; and
the second component including:
between approximately 30% and 60% diphenylmethane diisocynanate;
between approximately 30% and 60% modified MDI; and
between approximately 1% and 10% MDI homopolymer.

17. The apparatus of claim 15 further comprising:
a plurality of fasteners adhering the screen to the walls.

18. The apparatus of claim 15 wherein the screen comprises a wire mesh.

19. The apparatus of claim 15 wherein the screen comprises one of a composite and a metal netting.

20. A refrigeration device comprising:
a plurality of walls;
a screen positioned over at least one of the walls, the screen including a plurality of intersecting elements defining a plurality of openings; and
a polymer coating contacting the screen, and contacting the wall through the openings in the screen.
